(19) United States
(12) Patent Application Publication
(10) Pub. No.: US 2021/0144974 A1
(43) Pub. Date: May 20, 2021

(54) DEVICE FOR ACCOMODATING CHICKS

(71) Applicant: Hans-Jürgen Fienhage, Goldenstedt (DE)

(72) Inventor: Frank Rensing, Visbek (DE)

(73) Assignee: Hans-Jürgen Fienhage, Goldenstedt (DE)

(21) Appl. No.: 16/952,194

(22) Filed: Nov. 19, 2020

(30) Foreign Application Priority Data
Nov. 20, 2019 (DE) 102019008051.3

(51) Int. Cl. A01K 31/18; A01K 39/014; A01K 31/17

(52) U.S. Cl. CPC A01K 31/18; A01K 31/12; A01K 31/17; A01K 39/014

(57) ABSTRACT

A device for accommodating chicks in poultry rearing, having a grid floor. The grid floor has a sloping region

### CROSS REFERENCE TO RELATED APPLICATIONS

This application claims the benefit of and priority on German Patent Application No. 10 2019 008 051.3 having a filing date of 20 Nov. 2019.

### BACKGROUND OF THE INVENTION

### Technical Field

The invention relates to a device for accommodating chicks in poultry rearing, having a grid floor. In addition, the invention relates to a housing arrangement and to a poultry house.

### Prior Art

In a poultry house for the rearing of laying hens, the chicks are kept on grid floors in a plurality of rearing levels arranged one above the other. A manure belt is generally arranged beneath each grid floor. Drink dispensers are provided above the grid floors. Feed is made available in a feed trough which is open at the top. Grid floors with a small mesh size are provided for the chicks, so that the chicks do not fall through the mesh floors onto the manure belt.

Laying hens which have outgrown the chick stage and already lay eggs are likewise kept on grid floors in a plurality of levels (laying hen levels). Each laying hen level is equipped with a grid floor, nests, an egg collecting region, and an egg conveyor. A drink dispenser, a feed trough and a manure belt are likewise provided. The grid floor of the laying hen level can have a larger mesh size compared to the grid floor of the rearing level.

After the chicks have been reared, they must be rehoused from the poultry house for rearing into the poultry house for the laying hens. This is associated with a large amount of effort for personnel.

### BRIEF SUMMARY OF THE INVENTION

The object of the present invention is to provide a device which is suitable both for the rearing of laying hens (chicks) and for housing the egg-laying laying hens.

In order to achieve the object, the device according to the invention is a device for accommodating chicks in poultry rearing, having a grid floor, comprising a sloping region of the grid floor. In particular, a grid floor is provided with a sloping region. The grid floor is suitable for accommodating chicks, in particular also for chicks less than two weeks old, preferably also day-old chicks. The mesh size is adapted thereto. Contrary to what has hitherto been conventional in poultry rearing, the grid floor provided for rearing has a sloping region. This makes it possible for the poultry breeder to allow this region to be used also for laying hens. Owing to the sloping grid floor, the laid eggs automatically roll into a region which is here referred to as the egg collecting region. The eggs can be removed from there with little effort. The device is accordingly suitable both for chicks in poultry rearing and for housing laying hens.

According to a further concept of the invention, an egg conveyor can be provided following the sloping region of the grid floor. The laid eggs roll onto the egg conveyor and are conveyed away directly. The conveying direction preferably runs transversely to the direction in which the grid floor slopes. In particular, the egg conveyor is an egg belt known per se.

According to a further concept of the invention, the egg conveyor can have a removable lateral cover. The cover is to be provided and suitable for preventing chicks from reaching the egg conveyor. Only when the chicks are larger is the lateral cover raised to such an extent that eggs, but not the larger chicks, fit beneath it.

According to a further concept of the invention, a central egg channel can be provided. In particular, the grid floor has an egg channel in the center as the deepest region. The egg conveyor is arranged in the deepest region. Outside the deepest region, the grid floor is in the shape of a V with a very large opening angle, as shown, for example, in DE 20 2007 015 498 U1. A sloping region of the grid floor is provided on each side of the deepest region, such that the eggs are able to roll towards the deepest region.

According to a further concept of the invention, a feed trough can be provided on an elevated outer edge of the grid floor. Where there is a central egg channel, feed troughs are preferably provided on both mutually opposite edges of the grid floor.

According to a further concept of the invention, an approach region, in particular having an approach platform, can be provided at an outer edge of the grid floor or at mutually opposite outer edges. The approach platform is preferably adjustable between a sideways oriented, usable platform position and an upwardly oriented closed position. The movement of chicks from that region can thereby be prevented. Depending on the dimensions of the approach platform, further closing devices can be provided.

According to a further concept of the invention, the device for accommodating chicks in poultry rearing, having a grid floor, can have a vertically adjustable feed trough. The feed trough is in particular arranged at a distance from the outer edge of the grid floor. As a result of the vertical adjustment, the feed trough can grow with the chicks. Preferably, the distance is more than the width of the elongate feed trough or more than twice the width thereof.

According to a further concept of the invention, the feed trough is movable from a low position on the grid floor into a high position at a distance from the grid floor. In the low position, even young chicks are able to reach the feed in the feed trough. For very young chicks, the feed trough can have lateral feed outlet holes. Beneath the feed outlet holes, underlays which are impenetrable to feed, and which are preferably removable, can be provided on the grid floor.

According to a further concept of the invention, a stationary or adjustable sitting perch can be provided above the vertically adjustable feed trough. In particular, the sitting perch is vertically adjustable.

According to a further concept of the invention, the device for accommodating chicks in poultry rearing can have a dividing wall on the grid floor. By means of the dividing wall, the region provided for the chicks can temporarily be made smaller. In particular, the dividing wall is to ensure that the accommodation region for the chicks is close to the edges of the grid floor. The chicks can thereby more easily be reached by the personnel, for example for inoculations.

According to a further concept of the invention, the dividing wall can be adjustable, capable of being raised upwards or capable of being made smaller. Preferably, the dividing wall can be rolled up onto an upper winding shaft. This allows the adjustment of the dividing wall to be carried out centrally.

According to a further concept of the invention, a drinking station and a feed trough can be provided on one side of the dividing wall, and at least one feed trough can be provided on the other side of the dividing wall. When the dividing wall is active, only the drinking station and the feed trough on the one side are used, while the feed trough on the other side remains unused and does not have to be filled and/or cleaned.

According to a further concept of the invention, at least one of the feed troughs can have feed outlet holes. Preferably, this is a feed trough on the grid floor close to an approach platform.

According to a further concept of the invention, an approach region, in particular having an approach platform, can be provided on one side of the dividing wall and an egg collecting region can be provided on the other side of the dividing wall. The egg collecting region is preferably provided with an egg conveyor.

Advantageously, the approach platform can be adjustable between a sideways oriented, usable platform position and an upwardly oriented closed position. The adjustment can preferably take place by pivoting or folding. In particular, the folded approach platform serves as a side wall for delimiting the space for the chicks.

According to a further concept of the invention, an approach region, an adjustable dividing wall and an egg collecting region can be provided, wherein a vertically adjustable feed trough is provided in particular solely between the dividing wall and the approach region. The feed trough is of such a size that it is sufficient for the keeping of laying hens. As a result of the vertical adjustment, the feed trough can also be used by very young chicks. Preferably, the feed trough can then have feed outlet holes at the side. The height of the feed in the feed trough (the feed level) is adapted to the height of the feed outlet holes. If the feed outlet holes are to be used, the feed level in the feed trough is kept high, otherwise it is kept lower. A feed trough is preferably not provided between the dividing wall and the egg collecting region. This simplifies maintenance of the feed troughs as a whole.

A housing arrangement for husbandry in an aviary has a plurality of accommodation levels, wherein at least one accommodation level is a rearing level and at least one accommodation level is a laying hen level. This allows laying hens to be accommodated in a housing arrangement even when they are chicks. As soon as the chicks have become laying hens, they are transferred to the laying hen level or move to that level themselves.

According to a further concept of the invention, the housing arrangement can have a device as disclosed herein in the rearing level. The rearing level so formed can then at the same time be an accommodation level for the laying hens, or a laying hen level.

A poultry house according to the invention, in particular for the rearing of laying hens, can have a device as disclosed herein or a housing arrangement as disclosed herein.

### BRIEF DESCRIPTION OF THE DRAWINGS

Further features of the invention will become apparent from the remainder of the description and from the claims. Advantageous exemplary embodiments of the invention will be explained in greater detail hereinbelow with reference to drawings, in which:

FIG. 1 is an isometric representation of part of a housing arrangement;

FIG. 2 is a front view of the housing arrangement according to FIG. 1;

FIG. 3 shows the housing arrangement according to FIG. 1 without the two upper levels, that is to say showing only two levels;

FIG. 4 shows a detail of FIG. 2, namely a central egg channel with an egg conveyor;

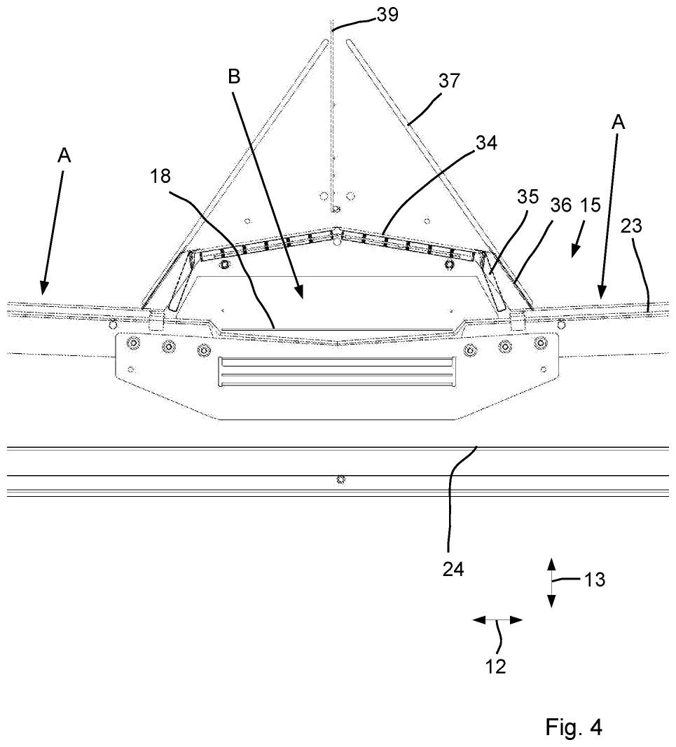

FIG. 5 shows a further detail of FIG. 2, namely an edge region between the egg channel and the approach platform;

FIG. 6 is a representation analogous to FIG. 5 for a further embodiment; and

FIG. 7 is a representation analogous to FIG. 5 for a further embodiment.

### DETAILED DESCRIPTION OF PREFERRED EMBODIMENTS

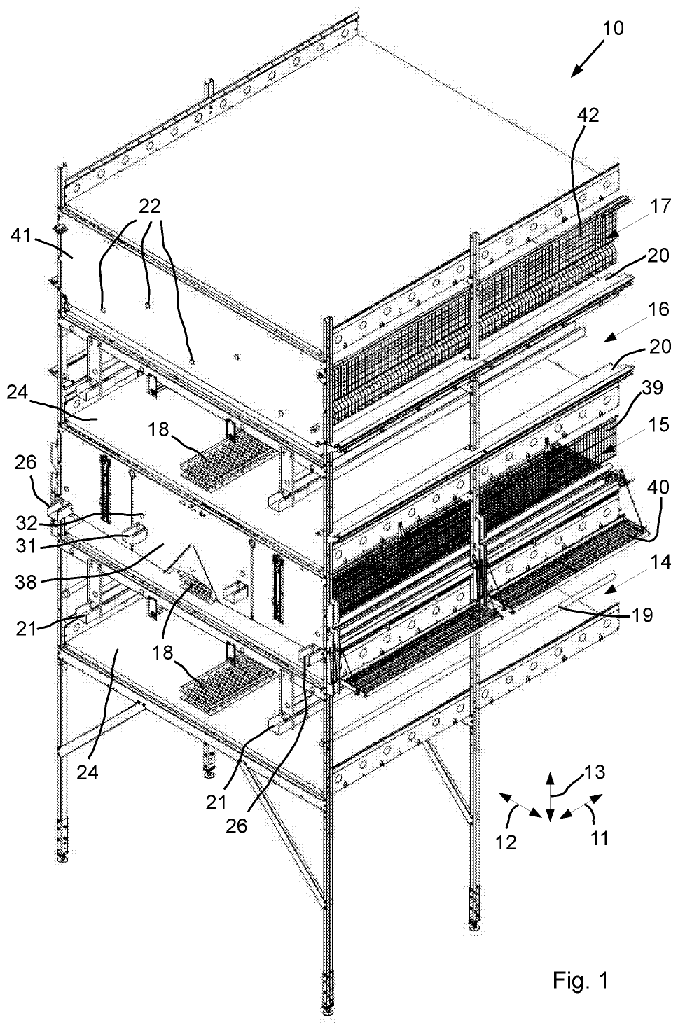

A housing arrangement 10 is provided for accommodating chicks in poultry rearing and at the same time for accommodating laying hens. The housing arrangement 10 is shown truncated in FIG. 1. The housing arrangement 10 actually extends substantially further than shown in the longitudinal direction according to the double-headed arrow 11, while the actual dimensions are shown by way of example for the arrangement in the transverse direction according to the double-headed arrow 12.

In the vertical direction according to the double-headed arrow 13, four accommodation levels are provided one above the other, namely, from bottom to top, a laying hen level 14, a rearing level 15, a laying hen level 16, and an additional level 17 at the very top.

The rearing level 15 is so configured and equipped that chicks can be accommodated. In particular, even young chicks, that is to say including so-called day-old chicks, are to be able to be accommodated in the rearing level 15. In addition, it is to be possible to accommodate fully grown laying hens in the rearing level 15. The laying hen levels 14, 16 are provided only for laying hens and are configured accordingly. The additional level 17 can be configured as an additional accommodation level for the laying hens, preferably with less equipment than the laying hen levels 14, 16.

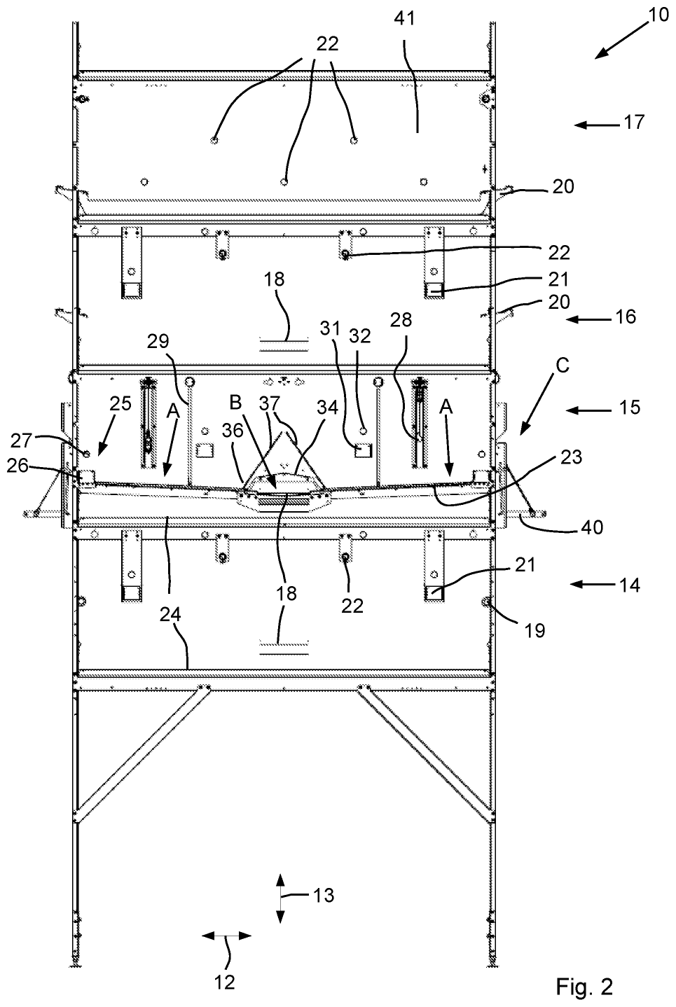

Grid floors and manure belts are provided in known manner in each of the accommodation levels 14 to 17, but they are not depicted in all the levels. The laying hen levels 16 are configured in a manner known per se. In FIG. 2 there are shown an egg conveyor 18 in the region of a central egg channel B and in the form of an egg belt, lateral approach perches 19 (laying hen level 14), approach boards 20 (laying hen level 16), elevated feed troughs 21 and drinking lines 28 arranged at a height. Not visible but nevertheless present are grid floors and nests and optionally further furnishing parts.

In the additional level 17, only sitting perches 22 at various heights and the approach boards 20 are shown. Preferably, grid floors and manure belts are also present. In particular feed troughs, drinking lines and egg conveyors are not provided.

The configuration of the laying hen levels 14, 16 with a sloping grid floor, a central egg conveyor and nests is shown by way of example in DE 20 2007 015 498 U1 of the applicant. The features mentioned therein can also be provided here in the region of the laying hen levels. The maximum mesh size (inside width) of the grid floors 23 in the laying hen levels 14, 16 is preferably up to 50 mm. In particular, a rectangular mesh cross-section is provided, with mesh sizes of from 20 to 25 mm in one direction and from 40 to 50 mm in the other direction, that is to say, for example, approximately 22 mm×47 mm.

The rearing level 15 has a grid floor 23 which slopes from the outside inwards in the shape of a V with a very large opening angle, and also a central egg conveyor 18, likewise as shown in DE 20 2007 015 498 U1. Sloping regions A of the grid floor 23 extend up to the egg channel B.

The mesh size of the grid floor 23 is particularly important. In order that the young chicks are able to sit on the grid floor 23 without falling onto the manure belt 24 beneath, the mesh size is relatively small, in any case significantly smaller than is conventional for fully grown laying hens. Preference is given to a maximum mesh size (inside width) of approximately from 18 to 24 mm, in particular approximately 22 mm, with a preferably square mesh cross-section, that is to say, for example, approximately 22 mm×22 mm.

The rearing level 15 has feed troughs 26 at edges 25 which are on the outside in the transverse direction (double-headed arrow 12), which feed troughs extend in the conventional manner in the longitudinal direction (double-headed arrow 11) and which are arranged on the grid floor 23. Above the feed troughs 26, at a small distance therefrom, there are provided sitting perches 27.

At a distance from the outer edges 25, that is to say inwards from the feed troughs 26, there are arranged vertically adjustable drinking lines 28. The height of the drinking lines 28 can thus grow with the size of the chicks.

Between the drinking lines 28 and the egg conveyor 18 there are provided upright, adjustable dividing walls 29. Preferably, the dividing walls 29 can be rolled up onto upper winding shafts 30. It is provided that the chicks in the first days of their life are housed in the region between the outer edges 25 and the lowered dividing walls 29. After a few days or weeks, the dividing walls 29 are raised or rolled up, so that the chicks have more room.

Feed troughs 31 with sitting perches 32 arranged above them are likewise provided between the dividing walls 29 and the egg conveyor 18. The feed troughs 31 and/or the sitting perches 32 are vertically adjustable. Young chicks need the feed troughs 31 on the grid floor 23, while older chicks are also able to take the feed from higher feed troughs. The sitting perches 32 are in any case used only by older chicks.

Feed conveyors, or feed chains, are provided in the feed troughs 21, 26, 31, so that feed can be supplied in an automated manner. In particular the feed troughs 26 provided in the region of the outer edges 25 of the rearing level 15 can have feed outlet holes, not shown, in an inner side wall 33 facing the egg conveyor 18. Underlays which are impermeable to feed are then preferably placed beneath the feed outlet holes, on which underlays small heaps of feed accumulate and can be used as a feed source by the young chicks.

In the rearing level 15, the egg conveyor 18 is provided with an upper cover 34 so that animals cannot reach the egg conveyor 18 or the eggs. Regions 35 laterally adjoining the cover 34 are open in order to allow the eggs to pass from the grid floor 23 onto the egg conveyor 18.

In order that young chicks cannot reach the egg conveyor 18, the open region 35 can be closed off by a barrier wall 36. The barrier wall 36 reaches down to the grid floor 23 and is vertically adjustable in inverted-V-shaped guides 37. The guides 37 can be arranged in transverse side walls 38, see in particular FIG. 1.

By means of the transverse side walls 38, closed compartments for the chicks can be formed in the rearing level 15. This is assisted by upright walls arranged along the outer edges 25, which upright walls are here provided in the form of barrier grids 39 and extend from the level located above preferably approximately down to the sitting perches 27.

The region beneath the barrier grids 39 can be closed by approach platforms 40, which can be folded from the sideways oriented platform position shown in FIG. 1 into an upwardly oriented closed position (not shown). In the closed position, the approach platforms 40 close off the region beneath the barrier grids 39. This region and/or the pivot region of the approach platforms 40 can therefore be referred to as the approach region C.

The additional level 17 can likewise be closed off on all sides. Transverse side walls 41 serve as a support for sitting perches 22. Longitudinal barrier grids 42 are removable or adjustable and allow access to the additional level 17 to be controlled. Finally, the additional level 17 is also covered at the top by a roof panel 45.

The rearing level 15 is here at the same time to serve as an accommodation level for fully grown laying hens. Once the chicks have reached an appropriate size, the dividing walls 29 can first be removed, or rolled up. At the same time or after the chicks have grown further, the barrier walls 36 in front of the open regions 35 of the egg conveyor 18 are removed or raised. The laying hens can then be accommodated and also lay eggs in the entire region of the rearing level 15. The eggs roll onto the egg conveyor 18 and are conveyed away in the longitudinal direction.

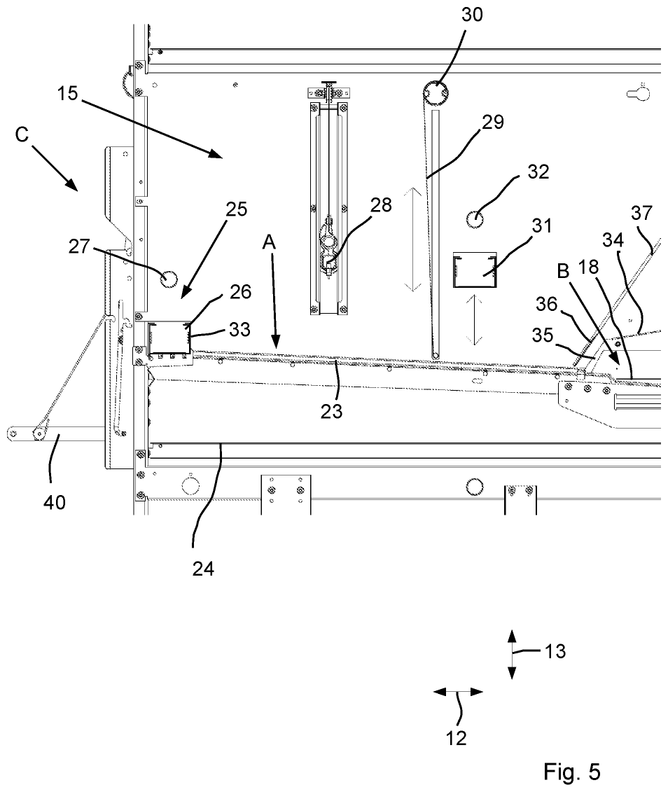

Different variants are conceivable for the specific configuration of the rearing level 15 with feed troughs and other furnishing details. For example, in contrast to the representation in FIG. 5, the feed troughs 31 beneath the sitting perches 32 can also be arranged stationarily and mounted, for example, in the transverse side walls 38, as is shown in FIG. 1.

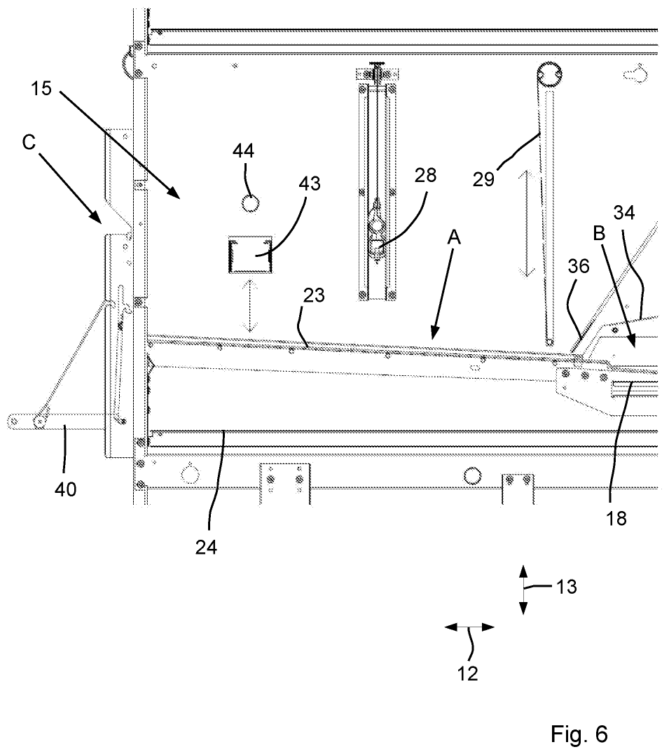

A particular variant is shown in FIG. 6. Here, feed troughs 43 are provided only between the dividing walls 29 and the outer edges 25, preferably between the drinking lines 28 and the outer edges 25. The dividing walls 29 can be arranged close to the barrier walls 36 or nearer to the drinking lines 28. Alternatively, dividing walls 29 or barrier walls 36 can be omitted. In the embodiment according to FIG. 6, the feed troughs 43 and/or sitting perches 44 are vertically adjustable, analogously to the feed troughs 31 and sitting perches 32 in FIG. 5.

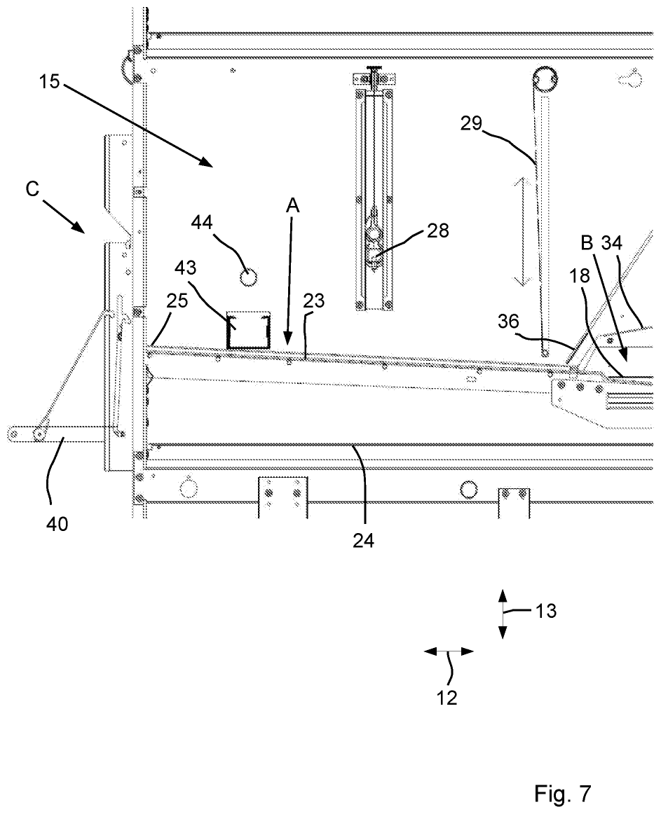

FIG. 7 shows a modification of the embodiment according to FIG. 6. In FIG. 7, the feed troughs 43 and sitting perches 44 are arranged stationarily, the feed troughs 43 directly on the grid floor 23, the sitting perches 44 thereabove.

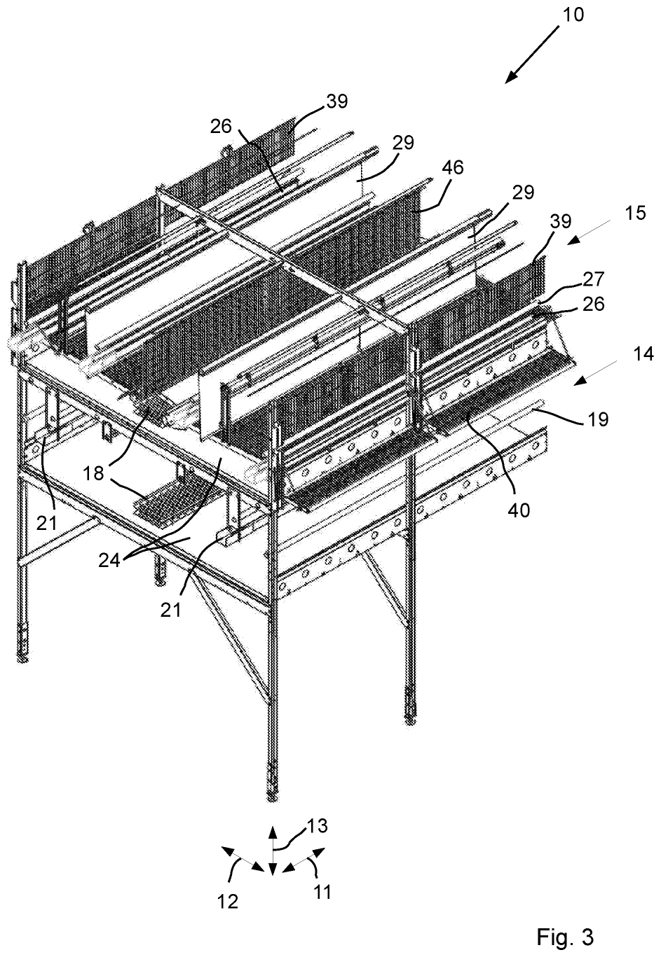

According to FIG. 3, an upright barrier grid 46 can also be provided centrally above the egg conveyor 18.

By means of the housing arrangement 10 shown with reference to several embodiments, chicks and laying hens can be housed in one arrangement. The rearing level 15, which is otherwise provided only for chicks, is at the same time also suitable and provided for accommodating laying hens.

### LIST OF REFERENCE SIGNS

10 housing arrangement
11 double-headed arrow (longitudinal direction)
12 double-headed arrow (transverse direction)
13 double-headed arrow (vertical direction)
14 laying hen level
15 rearing level
16 laying hen level
17 additional level
18 egg conveyor
19 approach perch
20 approach board
21 feed troughs (laying hen levels)
22 sitting perches (additional level)
23 grid floor
24 manure belt
25 outer edges
26 feed troughs (rearing level)
27 sitting perches (rearing level)
28 drinking lines
29 dividing walls
30 winding shafts
31 feed troughs
32 sitting perches
33 inner side wall
34 upper cover
35 open region
36 barrier walls
37 guides
38 transverse side walls
39 barrier grids
40 approach platform
41 transverse side walls
42 barrier grid
43 feed troughs
44 sitting perches
45 roof panel
46 barrier grid
A sloping region
B egg channel
C approach region

What is claimed is:

1. A device for accommodating chicks in poultry rearing, having a grid floor (23), comprising a sloping region (A) of the grid floor (23).

2. The device as claimed in claim 1, further comprising an egg conveyor (18) following the sloping region (A) of the grid floor (23).

3. The device as claimed in claim 2, further comprising a removable lateral cover (34) of the egg conveyor (18).

4. The device as claimed in claim 1, further comprising a central egg channel (B).

5. The device as claimed in claim 1, further comprising a feed trough (26) on an elevated outer edge (25) of the grid floor (23).

6. The device as claimed in claim 1, wherein an approach region (C) is provided at an outer edge (25) of the grid floor (23) or at mutually opposite edges (25).

7. A device for accommodating chicks in poultry rearing, comprising a grid floor (23) comprising a sloping region (A), and a vertically adjustable feed trough (31, 43).

8. The device as claimed in claim 7, wherein the feed trough (31, 43) is movable from a low position on the grid floor (23) into a high position at a distance from the grid floor (23).

9. The device as claimed in claim 7, further comprising a stationary or adjustable sitting perch (32, 44) above the feed trough (31, 43).

10. A device for accommodating chicks in poultry rearing, comprising a grid floor (23) comprising a sloping region (A), and a dividing wall (29) on the grid floor (23) or above the grid floor (23).

11. The device as claimed in claim 10, wherein the dividing wall (29) is adjustable, capable of being raised upwards or capable of being made smaller.

12. The device as claimed in claim 10, further comprising a drinking station and a feed trough (26) on one side of the dividing wall (29) and at least one feed trough (31) on the other side of the dividing wall (29).

13. The device as claimed in claim 12, wherein at least one of the feed troughs (26) has feed outlet holes.

14. The device as claimed in claim 10, further comprising an approach region on one side of the dividing wall (29) and an egg collecting region (B) on the other side of the dividing wall (29).

15. The device as claimed in claim 10, further comprising an approach region (C), an adjustable dividing wall (29) and an egg collecting region (B), wherein a vertically adjustable feed trough (43) is provided between the dividing wall (29) and the approach region (C).

16. A housing arrangement (10) for husbandry in an aviary, comprising a plurality of accommodation levels (14, 15, 16, 17), wherein at least one accommodation level is a rearing level (15) and at least one accommodation level is a laying hen level (16).

17. The housing arrangement as claimed in claim 16, further comprising a device for accommodating chicks in poultry rearing, having a grid floor (23) comprising a sloping region (A) of the grid floor (23), in the rearing level (15).

18. A poultry house, comprising a device for accommodating chicks in poultry rearing, having a grid floor (23) comprising a sloping region (A) of the grid floor (23), or a housing arrangement (10) for husbandry in an aviary, comprising a plurality of accommodation levels (14, 15, 16, 17), wherein at least one accommodation level is a rearing level (15) and at least one accommodation level is a laying hen level (16).
